(19) United States
(12) Patent Application Publication
(10) Pub. No.: US 2009/0084996 A1
(43) Pub. Date: Apr. 2, 2009

(54) SERVO VALVE

(75) Inventor: Markus Lingemann, Bochum (DE)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: TRW Automotive GmbH, Alfdorf (DE)

(21) Appl. No.: 12/237,586

(22) Filed: Sep. 25, 2008

(30) Foreign Application Priority Data
Sep. 28, 2007 (DE) DE202007013585.8

(51) Int. Cl. F16K 31/12

(52) U.S. Cl. 251/12

(57) ABSTRACT

A servo valve for a hydraulic power steering system includes a valve shaft that is rotatable about a valve axis, a valve sleeve that cooperates with and may be rotated in relation to the valve shaft, and a closure member for a valve return port. The closure member is movable between a first end position, in which it closes a flow cross-section of the valve return port at least partially, and a second end position, in which it substantially clears the flow cross-section of the valve return port. The closure member is urged towards one of the end positions by the supply pressure applied on a valve supply port by a hydraulic fluid.

### CROSS-REFERENCE TO RELATED APPLICATION

This application claims priority to German Patent Application No. 20 2007 013 585.8 filed Sep. 28, 2007, the disclosures of which are incorporated herein by reference in entirety.

### BACKGROUND OF THE INVENTION

The present invention relates to a servo valve for a hydraulic power steering system, including a valve shaft that is rotatable about a valve axis, and a valve sleeve that cooperates with and may be rotated in relation to the valve shaft.

A servo valve is a central constituent of a hydraulic power steering system which is able to provide a steering assist force to the driver of a vehicle. One example of such a power steering system is found in U.S. Pat. No. 4,819,545. Here, the valve shaft connected to a steering wheel and the valve sleeve connected to a steering gear are each provided with control grooves for controlling a hydraulic fluid flow through the servo valve. In an initial condition, in which the valve shaft and the valve sleeve are in the hydraulic center position in relation to each other, a hydraulic fluid flow supplied by a pump is fed to the servo valve through a valve supply port and is evenly distributed to two exits of the servo valve. When the valve shaft is rotated in one direction in relation to the valve sleeve, one of the exits is supplied with a larger portion of the hydraulic fluid flow. The hydraulic fluid flow may, for example, be directed to one side of the hydraulic cylinder so that a steering assist force is produced in a first direction. When the valve shaft is rotated in the opposite direction in relation to the valve sleeve, the steering assist force is also generated to act in the opposite direction. Fluid flowing back from the hydraulic cylinder to the servo valve is supplied to a fluid reservoir through a valve return port.

Servo valves that have a device for regulating the return flow pressure in order to reduce or prevent the appearance of cavitation phenomena in the power steering system have already been disclosed in the prior art.

For example, JP 58-202165 A describes a servo valve in which a return flow opening is largely exposed in the hydraulic center position of the servo valve. With increasing valve rotation, the flow cross-section of this opening is reduced, so that the return flow pressure rises. In this document, the apparatus for regulating the return flow pressure always acts contrary to a rotation of the servo valve out of its hydraulic center position, which results in an interference with the effect of a centering device (such as, e.g., a torsion rod). Such interference is generally undesirable since it makes an exact adjustment or control of the center position of the servo valve more difficult.

A feature of the invention is to provide a servo valve for hydraulic power steering systems which improves on the hydraulic stability of a steering gear and minimizes the risk of cavitation in the hydraulic power steering system.

### BRIEF SUMMARY OF THE INVENTION

In accordance with the invention, a servo valve for a hydraulic power steering system includes a valve shaft that is rotatable about a valve axis, a valve sleeve that cooperates with and may be rotated in relation to the valve shaft, and a closure member for a valve return port. The closure member is movable between a first end position, in which it closes a flow cross-section of the valve return port at least partially, and a second end position, in which it substantially clears the flow cross-section of the valve return port. The closure member is urged towards one of the end positions by a supply pressure applied on a valve supply port by a hydraulic fluid. Since in this case the movement of the closure member depends on the hydraulic pressure at the valve supply port, rather than directly on the rotation of the valve shaft in relation to the valve sleeve, a reaction of the closure member on a center positioning action of the servo valve is ruled out. The force for returning to the center position may therefore be adjusted by means of a centering apparatus without any undesirable influence by the closure member. In addition, an increase in the return flow pressure results in an improved damping response of the power steering system, which has an advantageous effect on the hydraulic stability of the steering gear.

In one embodiment the closure member includes a throttle opening which defines a minimum flow cross-section of the valve return port. The throttle opening prevents the valve return port from being completely closed and, hence, an excessive rise in the return flow pressure.

Preferably, the supply pressure urges the closure member towards its first end position. This means that as the supply pressure rises and as an attendant risk of cavitation in the servo valve increases, the closure member is urged more strongly into that end position in which the closure member at least partly closes the flow cross-section of the valve return port. A reduction in the flow cross-section will result in an increase of the return flow pressure, which counteracts the increasing risk of cavitation and largely prevents any cavitation phenomena from appearing.

In a further embodiment a spring member engages the closure member to urge the closure member towards its second end position. Since the spring member acts in opposition to the resultant force from the supply pressure of the hydraulic fluid, the spring stiffness may be used to adjust the movement of the closure member in a very simple way as a function of the supply pressure.

The spring member preferably engages an abutment which bears on the valve shaft in the axial direction. In this way, a spring force that acts upon the closure member relative to the valve shaft can be generated with little expense.

Here, the abutment may define a stop for the closure member in the first end position of the closure member. In the second end position of the closure member, it is preferably the valve sleeve that defines a stop for the closure member. With the abutment and the valve sleeve being provided at any rate, it is especially simple to establish defined end positions for the closure member to be movable between these end positions.

In another embodiment the closure member is in the form of a closure sleeve which encloses the valve shaft and extends between the valve shaft and the valve sleeve. The valve shaft thus constitutes a guide for the closure member, so that, in addition to the end positions of the closure member, the movement thereof can be likewise clearly defined with little effort. As a consequence, the flow cross-section of the valve return port and thus the return flow pressure may be regulated precisely and continuously as a function of the supply pressure.

In a sleeve-shaped design, the closure member is preferably movable in the axial direction, an end face of the sleeve-shaped closure member being acted upon by the supply pressure.

The valve shaft, the valve sleeve, and the closure member may, for example, define an annular chamber which is in communication with the valve supply port. Provision of such an annular chamber is of particular advantage to an axial movement of the sleeve-shaped closure member because in this case the closure member is acted upon uniformly in the axial direction by means of its end face. In this way, any impairment of the movement of the closure member, e.g. by jamming, is largely ruled out.

Preferably, in this embodiment a sealing member is provided for sealing the annular chamber, and it is particularly preferred for the sealing member to be received in an internally surrounding groove of the valve sleeve. The sealing member ensures that the closure member can slide between its end positions without problems, while leakage is minimized at the same time. An internally surrounding groove in the valve sleeve allows the sealing member to be positioned and fixed in place between the valve sleeve and the closure member with little expense. Alternatively or additionally, a sealing member may also be provided in a recess of the valve shaft to provide for a sealing action between the valve shaft and the closure member.

In a further embodiment of the servo valve, the closure member and the valve sleeve are identical. This means that the valve sleeve is movable in the axial direction in relation to the valve shaft, the maximum relative movement amounting to less than 2 mm, particularly preferably less than 1 mm.

In this embodiment the valve sleeve may be urged towards its second end position by a spring member, the spring member engaging an abutment which bears on the valve shaft in the axial direction. By means of this abutment and the spring member, a spring force is produced with little effort which acts upon the valve sleeve relative to the valve shaft. The spring member acts in opposition to the resultant force from a supply pressure applied by the hydraulic fluid so that, using the spring stiffness, it is very simple to adjust the movement of the valve sleeve as a function of the supply pressure.

The valve sleeve and the abutment preferably define an annular gap here which is adapted to influence the flow cross-section of the valve return port. In comparison with conventional designs, the number of components additionally required for this configuration of the servo valve is especially small. Only the abutment and the spring member are required to adjust the desired return flow pressure by means of a simple axial displacement of the valve sleeve.

Preferably, provision is made in the abutment and/or in the valve sleeve for at least one notch which in the first end position of the valve sleeve defines a minimum flow cross-section of the valve return port. This notch prevents the valve return port from closing completely and, hence, the return flow pressure from rising excessively.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a perspective view of a servo valve according to the invention;

FIG. 2 shows a perspective sectional view of a detail of the servo valve according to the invention as shown in FIG. 1;

FIG. 3 shows a diagrammatic detail section through the servo valve according to the invention as shown in FIG. 1, at a low supply pressure;

FIG. 4 shows a diagrammatic detail section through the servo valve according to the invention as shown in FIG. 1, at a high supply pressure;

FIG. 5 shows a diagrammatic detail section through a first alternative embodiment of the servo valve according to the invention;

FIG. 6 shows a diagrammatic detail section through a second alternative embodiment of the servo valve according to the invention, at a low supply pressure; and

FIG. 7 shows a diagrammatic detail section through the servo valve according to the invention as shown in FIG. 6, at a high supply pressure.

### DETAILED DESCRIPTION OF THE INVENTION

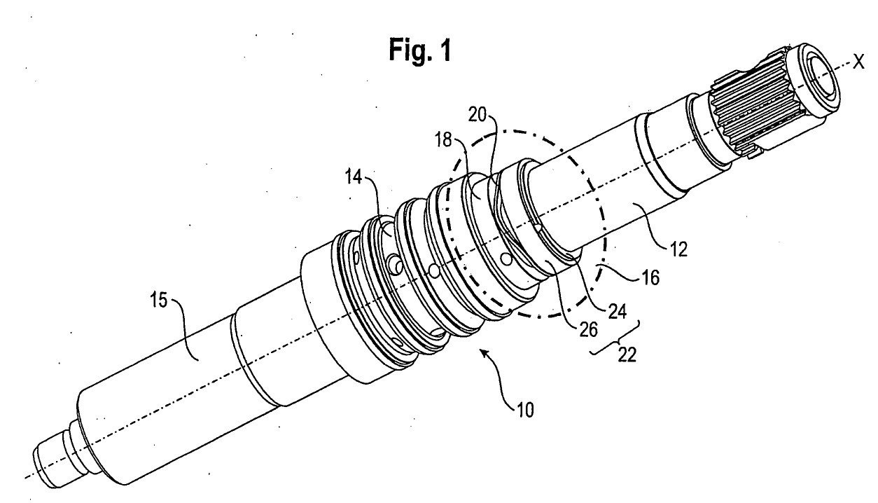

FIG. 1 shows a servo valve 10 having a valve shaft 12 and a valve sleeve 14 that cooperates with the valve shaft 12. The valve shaft 12 is coupled to a steering wheel (not shown) for joint rotation therewith about a valve axis X, while the valve sleeve 14 is connected to a steering gear, for example to an output shaft 15, provided with a pinion, of the steering gear and may be rotated in relation to the valve shaft 12. The servo valve 10 discussed here is a hydraulic servo valve the basic structure of which is known from the prior art, for example from U.S. Pat. No. 4,819,545. This document is expressly incorporated herein in its entirety by reference.

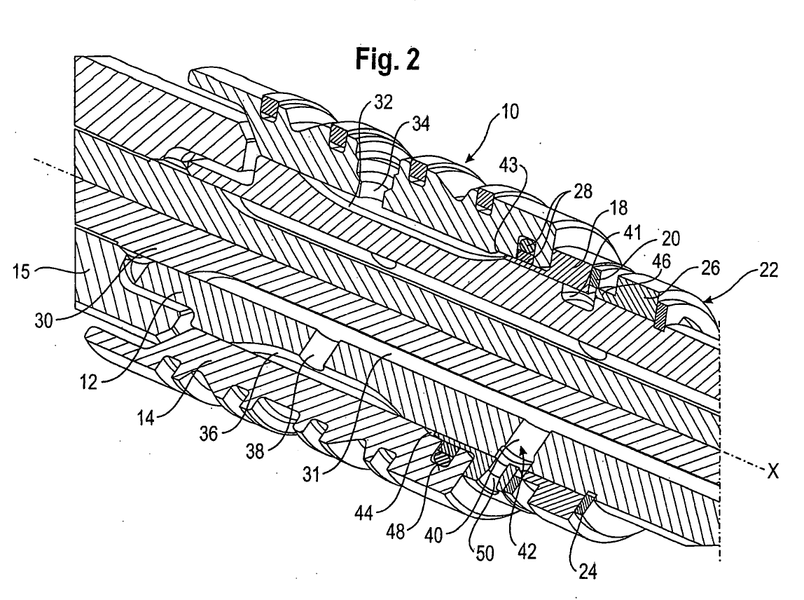

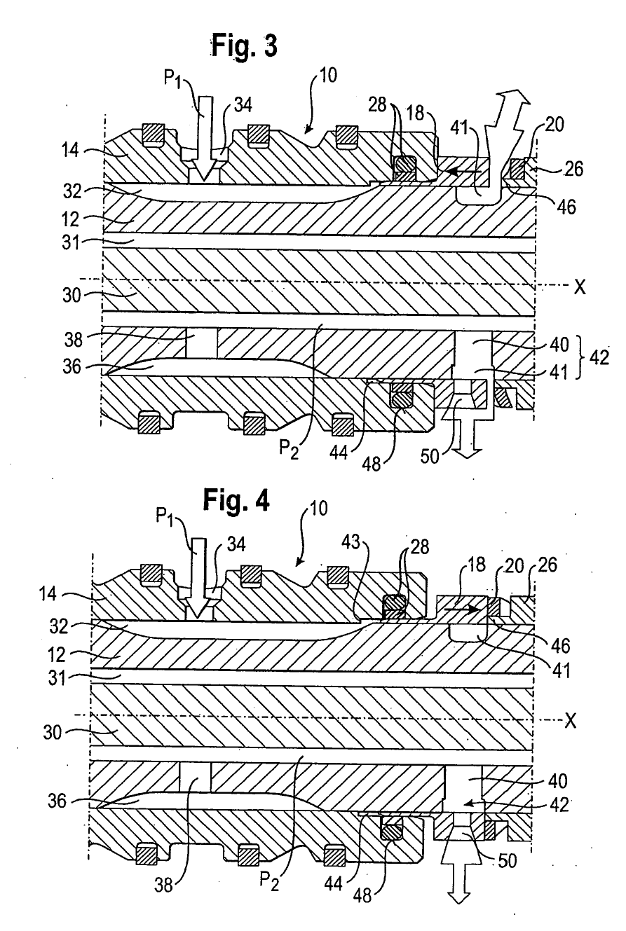

The special characteristic of the servo valve 10 is an assembly 16 which is highlighted in FIG. 1 (cf. dash-dot framing) and which, depending on a supply pressure P₁ of the servo valve 10, adjusts a flow cross-section of a valve return port and thus a return flow pressure P₂ (cf. FIGS. 3 and 4). The assembly 16 comprises a closure member 18, a spring member 20, and an abutment 22 which in the present case is made up of a retaining ring 24 and an abutment sleeve 26. The assembly 16 further comprises two sealing members 28 which may be clearly seen in FIGS. 2 to 4.

FIG. 2 shows a sectional view of a cutout detail of the servo valve 10 according to FIG. 1. It is visible here that the valve shaft 12 and the output shaft 15 are at least partly in the form of a hollow shaft to receive in their interior a torsion rod 30 which functions as a centering device and urges the valve shaft 12 to a hydraulic center position of the servo valve 10 in relation to the valve sleeve 14. The remaining space between the valve shaft 12 and the torsion rod 30 is made use of as a return flow duct 31 for hydraulic fluid. The valve shaft 12 and the valve sleeve 14 include cooperating control grooves that determine the hydraulic fluid flow in the servo valve 10. FIG. 2 shows a first control groove 32 in the valve shaft 12, the control groove 32 communicating with a valve supply port 34 which is configured as a valve sleeve bore. Further illustrated is a second control groove 36 in the valve shaft 12, this control groove 36 communicating, by means of a valve shaft bore 38 and the return flow duct 31, with a valve return port 42 which is configured as a radial bore 40 and an annular groove 41.

The assembly 16 is arranged on a side of the valve sleeve 14 opposite the output shaft 15. The valve sleeve 14, which is otherwise largely closely adjacent to the valve shaft 12, has a radial shoulder 43 in this area, so that the closure member 18 can extend between the valve shaft 12 and the valve sleeve 14, the closure member 18 being in the form of a closure sleeve enclosing the valve shaft 12. Together with the valve shaft 12 and the valve sleeve 14, an end face of the sleeve-shaped closure member 18 facing the output shaft 15 defines an annular chamber 44 which communicates with the valve supply port 34 via the first control groove 32. To connect the valve supply port 34 with the annular chamber 44, the first control groove 32 (supply groove) extends axially farther towards the closure member 18 than the second control groove 36 (return groove), as can be clearly seen in FIGS. 2 to 4. The sleeve-shaped closure member 18 is movable in the axial direction and is urged away from the valve sleeve 14 by means of its end face defining the annular chamber 44, by a supply pressure P₁ applied by a hydraulic fluid acting on the valve supply port 34. In the opposite direction, i.e. towards the valve sleeve 14, the closure member 18 is acted upon by the spring member 20. In the present example, the spring member 20 is in the form of an undulating washer which engages an end face of the sleeve-shaped closure member 18 facing away from the output shaft 15 and rests axially against the abutment 22. In FIG. 2 the abutment 22 is made up of the retaining ring 24 which is firmly connected with the valve shaft 12 in the axial direction and of the abutment sleeve 26 which is engaged by the spring member 20. The abutment sleeve 26 further includes an axial extension 46 serving as a stop for the closure member 18 in a first end position of the closure member 18.

The sleeve-shaped closure member 18 is radially widened between the valve sleeve 14 and the spring member 20 so as to produce a larger surface for engagement by the spring member 20 and an axial contact surface which, in a second end position of the closure member, rests against an axial end face of the valve sleeve 14. In other words, the valve sleeve 14 constitutes a stop for the closure member 18 in the second end position of the closure member 18.

The sealing members 28 are provided to minimize any undesirable leakage of hydraulic fluid out of the annular chamber 44. These sealing members 28 are in the form of sealing rings and are accommodated in an encircling groove 48 of the valve sleeve 14. They are elastically compressed between the valve sleeve 14 and the closure member 18 in the radial direction and force the closure member 18 against the valve shaft 12, so that the connection between the closure member 18 and the valve shaft 12 is also largely tight. The materials of the components involved here are selected such that the coefficients of friction between the closure member 18 and the valve shaft 12 or the sealing members 28 are so low that they only insignificantly hinder any movement of the closure member 18 in the axial direction and in the peripheral direction. Alternatively or additionally, such sealing members 28 may also be accommodated on the inside of the closure member 18 in a groove of the valve shaft 12 (not shown).

The functioning of the assembly 16 when the servo valve 10 is in operation will now be described in greater detail with reference to FIGS. 3 and 4:

The closure member 18 is always urged into its second end position by the spring member 20 at a constant predefined spring force. In this second end position, it is in contact with the valve sleeve 14 and substantially clears the flow cross-section of the valve return port 42 (FIG. 3). Acting contrary to the spring force is a force that results from the supply pressure P₁ applied by the hydraulic fluid at the valve supply port 34. In fact, the hydraulic fluid is introduced into the annular chamber 44 through the axially extended first control groove 32, so that it acts on the axial end face of the closure member 18. As a result, the supply pressure P₁ applied by the hydraulic fluid acting on the valve supply port 34 urges the closure member 18 towards its first end position, in which the abutment 22 or, to be more precise, the axial extension 46 of the abutment sleeve 26, forms a stop for the closure member 18 (FIG. 4). The closure member 18 can, however, not move to this first end position until the resultant force produced by the supply pressure P₁ of the hydraulic fluid exceeds the spring force exerted by the spring member 20. Such a rise in pressure occurs, for example, when the servo valve 10 is rotated out of its hydraulic center position.

As a result of the axial movement of the closure member 18 out of its second end position and into its first end position, the flow cross-section of the valve return port 42 is reduced (cf. FIGS. 3 and 4).

While the closure member 18 exposes an annular gap via which hydraulic fluid can leave the annular groove 41 of the valve return port 42 when the closure member 18 is in its second end position as shown in FIG. 3, this annular gap is closed when the closure member 18 is in its first end position as shown in FIG. 4. In this connection, it should be noted that the spring member 20 is configured such that it only insignificantly hinders a hydraulic fluid flow in the second end position of the closure member 18. In the present example, the spring member 20, which is in the form of an undulating washer, is in contact with the closure member 18 only in sections and, in the second end position of the closure member 18, it is within the flow of the hydraulic fluid.

The flow cross-section of the valve return port 42 in the second end position of the closure member 18 is normally selected such that the return flow pressure P₂ substantially corresponds to the pressure in a fluid reservoir, i.e. atmospheric pressure, for example. The closure member 18 then has no throttling function and the hydraulic fluid may essentially flow off freely to the fluid reservoir. Due to the annular gap becoming narrower when the closure member 18 moves to its first end position, the flow cross-section of the valve return port 42 decreases continuously until, in the first end position of the closure member 18, the annular gap is substantially closed. The closure member 18 therefore acts like a throttle, so that the return flow pressure P₂ rises upstream of the closure member 18. On account of the increase in the return flow pressure P₂, for one thing the damping of the power steering system improves and, for another thing, the occurrence of cavitation phenomena upstream of the closure member 18, that is, in particular also in the servo valve 10, is largely prevented. A return flow pressure of only a few bars is typically sufficient to minimize or prevent the cavitation phenomena. Therefore, in order to avoid an excessive pressure rise, the closure member 18 includes a throttle opening 50 which defines a minimum flow cross-section of the valve return port 42.

By having the assembly 16 operate in this way, any occurrence of cavitation phenomena in the servo valve 10 can be reliably prevented or minimized with little effort involved. The additional space required by the assembly 16 in the axial direction is minimal and may possibly be compensated for in some other place so that, in comparison with conventional servo valves, there is little or no change at all in the external dimensions. Also, almost no modifications need to be made to the conventional servo valve components, so that a change-over of production is unproblematic. In the present example, it is merely the first control groove 32 in the valve shaft 12 and the axial end of the valve sleeve 14 facing the closure member 18 that require structural adjustment.

Another advantage of the servo valve 10 described resides in the fact that the increase in the return flow pressure P₂ for preventing cavitation phenomena occurs only when a risk of cavitation actually exists. In the case of a low to medium supply pressure P₁, as prevails particularly in a hydraulic center position of the servo valve 10 for example, the risk of cavitation is low, so that the return flow pressure P₂ need not be raised (FIG. 3). As the pressure P₁ prevailing at the valve supply port 34 rises, as is, for example, the case when the servo valve 10 is rotated out of the hydraulic center position, the risk of cavitation markedly increases. For this reason, in situations such as this the flow cross-section of the valve return port 42 is at least partially closed by the closure member 18 and, in this way, the return flow pressure P₂ is raised to prevent the appearance of cavitation.

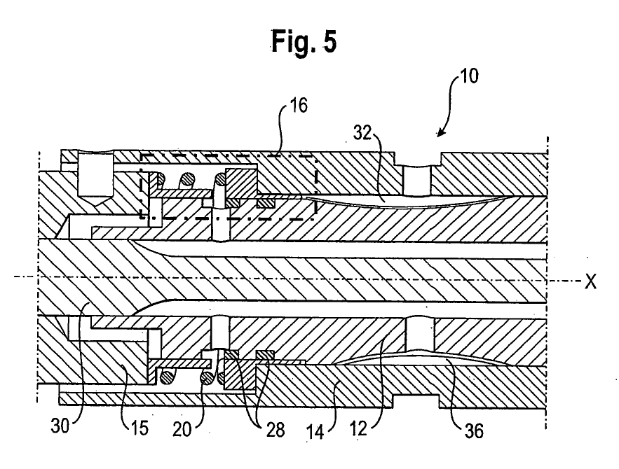

FIG. 5 shows a detail section through the servo valve 10 in accordance with an alternative embodiment. Since this alternative embodiment of the servo valve 10 essentially corresponds to the embodiment according to FIGS. 1 to 4 in terms of its basic design and general mode of operation, in this respect reference will be made to the description given in relation to FIGS. 1 to 4 and only the differences between the embodiments will be discussed below.

An essential difference is the altered position of the assembly 16. While in the embodiment according to FIG. 5 the assembly 16 for adjusting the flow cross-section is arranged at an axial end of the valve sleeve 14 adjacent to the output shaft 15, in the embodiment according to FIGS. 1 to 4 this assembly 16 is arranged at the opposite axial end of the valve sleeve 14. This does not result in any changes in function.

In addition, the spring member 20 which in FIGS. 1 to 4 is in the form of an undulating washer, is configured as a helical spring in the embodiment according to FIG. 5, and the sealing members 28 are provided in encircling grooves of the valve shaft 12, rather than in the valve sleeve 14.

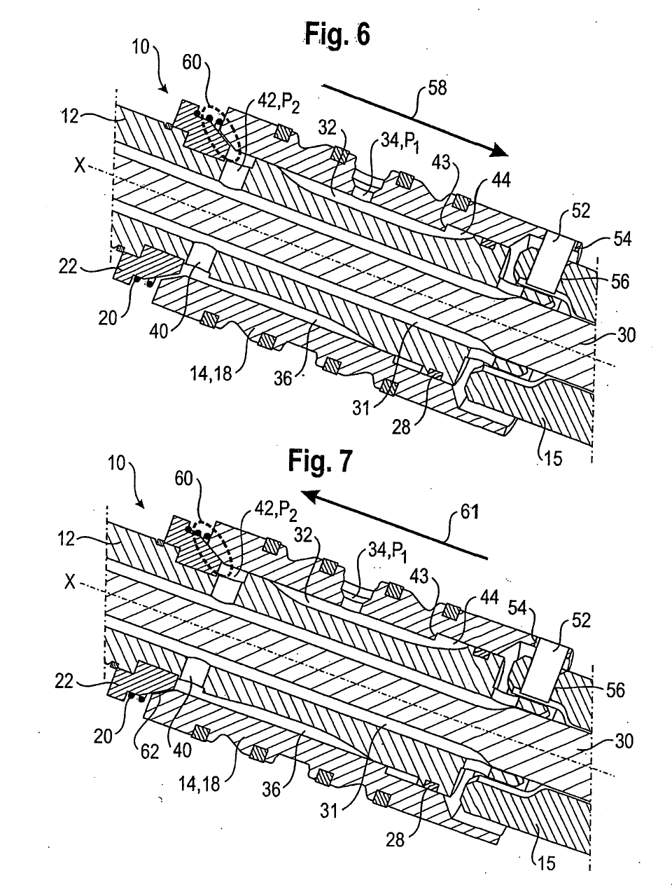

FIGS. 6 and 7 show detail sections of a further alternative embodiment of the servo valve 10. With the basic mode of operation largely corresponding to that of the embodiment according to FIGS. 1 to 4, reference is again made to the description relating to FIGS. 1 to 4 and only the differences between the embodiments are discussed below. Components that correspond to one another have been denoted by the same reference numerals.

In this embodiment the closure member 18 and the valve sleeve 14 are identical. This means that, in contrast to the embodiments described above, no separate closure member 18 is provided, but the valve sleeve 14 itself is axially movable between the first end position (FIG. 7) and the second end position (FIG. 6) in relation to the valve shaft 12 or the output shaft 15, the movement of the valve sleeve 14 between the end positions being on the order of 1 mm, preferably less than 1 mm. It is therefore necessary to make sure in designing the valve that a relative movement is possible between the valve sleeve 14 and the valve shaft 12 or the output shaft 15 that is held to be axially non-displaceable in relation to the valve shaft 12. FIGS. 6 and 7 show that the valve sleeve 14 and the output shaft 15 are connected by a pin 52, for example, which engages into openings 54, 56 in the valve sleeve 14 and the output shaft 15, respectively. In the present case, at least one of the openings 54, 56 is made to have an axial clearance to allow a relative movement between the valve sleeve 14 and the output shaft 15.

Analogous to the embodiments described above, the valve sleeve 14 which is in the form of the closure member 18 is urged towards the second end position by the spring member 20, which is indicated by an arrow 58 in FIG. 6. The axial clearance in the openings 54, 56 permits a certain axial movement of the valve sleeve 14 towards the output shaft 15 before the pin 52 forms a stop for the valve sleeve 14 and thus defines the second end position.

As in the preceding embodiments, the spring member 20 engages the abutment 22 which bears on the valve shaft 12 in the axial direction. But unlike in the preceding embodiments, the abutment 22 and the valve sleeve 14 define an annular gap 60 part of which defines the flow cross-section of the valve return port 42. In the second end position of the valve sleeve 14, this annular gap 60 reaches its maximum gap width, so that the flow cross-section is substantially exposed.

As the supply pressure P₁ applied by the hydraulic fluid at the valve supply port 34 rises, the pressure in the annular chamber 44 and, hence, the resultant force on an end face section of the valve sleeve 14, specifically on the radial shoulder 43 of the valve sleeve 14, also rises. This resultant force is directed towards the abutment 22, counter to the spring force of the spring member 20, which is indicated by an arrow 61 in FIG. 7. The axial clearance in the openings 54, 56 allows the valve sleeve 14 to move axially towards the abutment 22, the gap width of the annular gap 60 being reduced until the valve sleeve 14 finally rests against the abutment 22 in its first end position (FIG. 7).

Provided in the abutment 22 and/or in the valve sleeve 14 is preferably at least one notch 62 which in the first end position of the valve sleeve 14 defines a minimum flow cross-section of the valve return port 42, thus preventing the return flow pressure P₂ from rising excessively.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A servo valve for a hydraulic power steering system comprising:
a valve shaft that is rotatable about a valve axis;
a valve sleeve that cooperates with and may be rotated in relation to said valve shaft; and
a closure member for a valve return port, said closure member being movable between a first end position, in which it closes a flow cross-section of said valve return port at least partially, and a second end position, in which it substantially clears said flow cross-section of said valve return port;
wherein said closure member is urged towards one of said end positions by a supply pressure applied on a valve supply port by a hydraulic fluid.

2. The servo valve according to claim 1, wherein said closure member includes a throttle opening which defines a minimum flow cross-section of said valve return port.

3. The servo valve according to claim 1, wherein said supply pressure urges said closure member towards its first end position.

4. The servo valve according to claim 1, wherein a spring member engages said closure member to urge said closure member towards its second end position.

5. The servo valve according to claim 4, wherein said spring member engages an abutment which bears on said valve shaft in an axial direction.

6. The servo valve according to claim 4, wherein in said first end position of said closure member, said abutment constitutes a stop for said closure member.

7. The servo valve according to claim 1, wherein said closure member is in the form of a sleeve and is movable in an axial direction, an end face of said sleeve-shaped closure member being acted upon by said supply pressure.

8. The servo valve according to claim 1, wherein said valve shaft, said valve sleeve, and said closure member define an annular chamber which is in communication with said valve supply port.

9. The servo valve according to claim 8, wherein a sealing member is provided for sealing said annular chamber.

10. The servo valve according to claim 9, wherein said sealing member is received in an internally surrounding groove of said valve sleeve.

11. The servo valve according to claim 1, wherein in said second end position of said closure member, said valve sleeve defines a stop for said closure member.

12. The servo valve according to claim 1, wherein said closure member is in the form of a closure sleeve which encloses said valve shaft and extends between said valve shaft and said valve sleeve.

13. The servo valve according to claim 1, wherein said closure member and said valve sleeve are identical.

14. The servo valve according to claim 13, wherein said valve sleeve is urged towards its second end position by a spring member, said spring member engaging an abutment which bears on said valve shaft in an axial direction.

15. The servo valve according to claim 14, wherein said valve sleeve and said abutment define an annular gap at least one notch is provided in at least one of said abutment and said valve sleeve, said at least one notch defining a minimum flow cross-section of said valve return port in said first end position of said valve sleeve.
